(19) United States
(12) Patent Application Publication
(10) Pub. No.: US 2009/0066990 A1
(43) Pub. Date: Mar. 12, 2009

(54) Image processing system, image processing method, image processing program, and image forming apparatus

(76) Inventors: Hidekazu Segawa, Kanagawa (JP); Takashi Nakamura, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/665,831

(22) PCT Filed: Aug. 10, 2006
(86) PCT No.: PCT/JP2006/016134

§ 371 Date: Apr. 20, 2007

(30) Foreign Application Priority Data
Aug. 22, 2005 (JP) 2005-240303
Jul. 18, 2006 (JP) 2006-195981

(51) Int. Cl. G06F 3/12

(52) U.S. Cl. 358/1.15

(57) ABSTRACT

An image processing system processes image data. A log creating part acquires log information regarding processing of the image data. A log saving part saves the log information. A document data saving part saves as document data the image data and a log ID for identifying the log information.

### TECHNICAL FIELD

The present invention relates to image processing techniques and, more particularly, to an image processing system, method and program which records logs regarding processed image data and an image forming apparatus using such an image processing system, method or program.

### BACKGROUND ART

In recent years, the performance of copy machines and multi-function peripheral machines has been improved such that a difference between an original and a copy cannot be recognized visually. Additionally, electronic documents printed by printers have also become very clear images. Under such circumstances, it is possible that confidential documents are copied illegally or confidential electronic data is printed out illegally.

Thus, it is suggested to record logs, when processing images, as to who copied or printed out which document and when. For example, refer to the following Patent Documents 1-5.

Patent Document 1: Japanese Laid-Open Patent Application No. 2004-201068

Patent Document 2: Japanese Laid-Open Patent Application No. 7-248943

Patent Document 3: Japanese Laid-Open Patent Application No. 10-11330

Patent Document 4: Japanese Laid-Open Patent Application No. 10-178511

Patent Document 5: Japanese Laid-Open Patent Application No. 2004-102549

However, it is not clear what document was copied or printed out according to the information regarding who copied or printed out which document and when. For example, it is, possible to tamper a document name. Additionally, even if a person who performed image processing can be identified, such information has less significance if the image processing system used was one that the particular person has used usually.

### DISCLOSURE OF THE INVENTION

It is a general object of the present invention to provide a novel and useful image processing system, method and program in which the above-mentioned problems are eliminated.

A more specific object of the present invention is to provide an image processing system, method and program which can identify a document which was subjected to image processing.

In order to achieve the above-mentioned objects, there is provided according to one aspect of the present invention an image processing system for processing image data, comprising: a log creating part that acquires log information regarding processing of the image data; a log saving part that saves the log information; and a document data saving part that saves as document data the image data and a log ID for identifying the log information.

In the image processing system according to the present invention, the document data may further include at least one of a document ID for identifying the document data and a document name which is a name of the document data. The log information may include at least one of a user who designated the processing, a time at which the processing was started, and a time at which the processing was ended.

The image processing system according to the present invention may further comprise a document data storing part in which the document data is stored and a log storing part in which the log information is stored. The image processing system according to the present invention may further comprise a display part that displays the image data and the log information corresponding to the image data.

In the image processing system according to the present invention, the log saving part and the document saving part may describe the log information and the log ID in XML and may save the log information and the log ID. The display part may display the log information by deleting at least one of items of the log information. The log saving part may saves the log information in the log storing part after deleting at least one of items of the log information.

In the image processing system according to the present invention, when there are a plurality of jobs with respect to the same image data, the document data having one log ID may be stored in a document data storing part, and the log information containing the one log ID may be set as a parent log and log information corresponding to each of the plurality of jobs may be set as a child log so as to store the parent log and the child log in a log storing part.

In the image processing system according to the present invention, the log saving part and the document data saving part may save the log information and the log ID with respect to a job extracted by sampling. A frequency of the sampling may be changeable.

Additionally, there is provided according to another aspect of the present invention an image processing method for processing image data, comprising: acquiring log information regarding processing of the image data; and saving the log information and also saving as document data the image data and a log ID for identifying the log information. At least one of a document ID for identifying the document data and a document name which is a name of the document data may be included further in the document data. At least one of a user who designated the processing, a time at which the processing was started, and a time at which the processing was ended may be included in the log information.

The image processing method according to the present invention may further comprise describing the log information and the log ID in XML when saving the log information and the log information. At least one of items of the log information may be deleted when displaying the log information.

In the image processing method according to the present invention, at least one of items of the log information may be deleted when saving the log information. The log information and the log ID may be saved with respect to a job extracted by sampling.

Additionally, there is provided another aspect of the present invention a computer executable image processing program causing a computer to perform an image processing method for processing image data, comprising: acquiring log information regarding processing of the image data; and saving the log information and also saving as document data the image data and a log ID for identifying the log information.

Further, there is provided according another aspect of the present invention an image forming apparatus for processing an image using image data, comprising: a log creating part that acquires log information with respect to the processing of the image data; a log saving part that saves the log information; a document data saving part that saves as document data the image data and a log ID for identifying the log information; and a display part that displays the image data and the log information corresponding to the image data.

Other objects, features and advantages of the present invention will become more apparent from the following detailed description when read in conjunction with the accompanying drawings.

### BRIEF DESCRIPTION OF THE DRAWINGS

FIG. 1 is an illustration of an image processing system according to an embodiment of the present invention;

FIG. 2 is an illustration of an image processing apparatus;

FIG. 3 is a block diagram of a software structure of the image processing apparatus;

FIG. 4 is an illustration of document data and log;

FIG. 5 is an illustration showing details of bibliography information;

FIG. 6 is an illustration showing details of log;

FIG. 7 is a sequence chart of a process of relating log and document data;

FIG. 8 is an illustration of a screen displaying log and image data;

FIG. 9 is an illustration of a detail screen;

FIG. 10 is an illustration showing an example of display at clients when versions of a log management function are different;

FIG. 11 is an illustration showing an example of compression of logs saved in a log server;

FIG. 12 is an illustration showing logs of jobs having a parent-child relationship; and

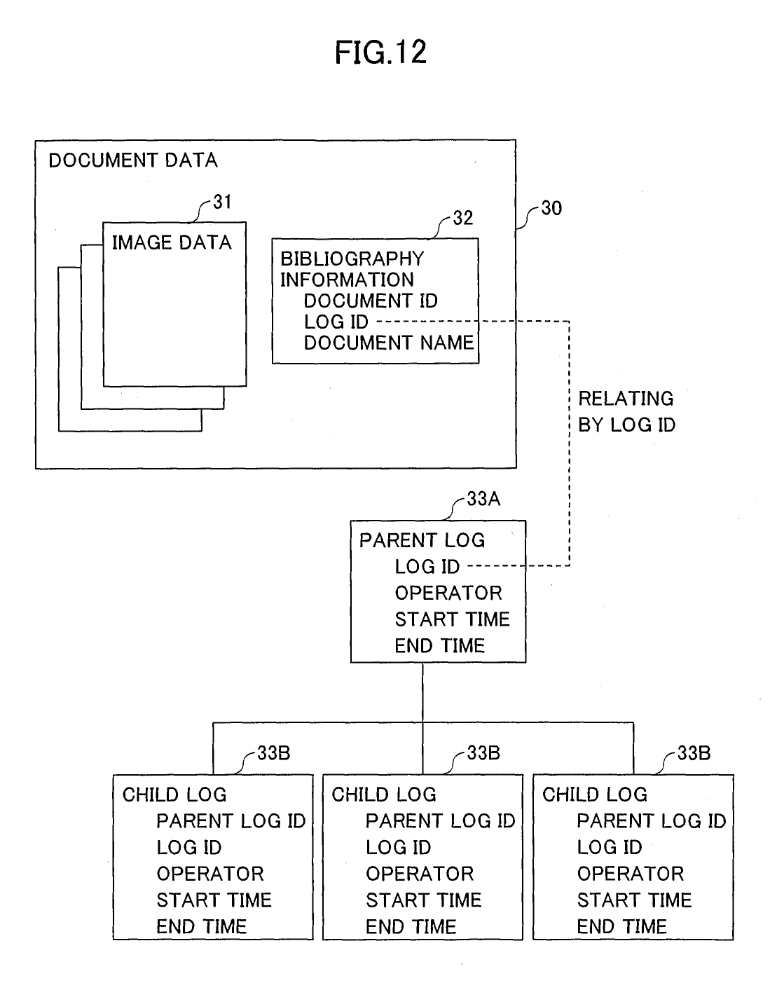

FIG. 13 is an illustration of details of logs of jobs having a parent-child relationship.

### BEST MODE FOR CARRYING OUT THE INVENTION

A description will now be given, with reference to the drawings, of an embodiment of the present invention. In the embodiment of the present invention, an object to be submitted to image processing is an original document or electronic data. The original document is a sheet of paper on which an image to be copied or facsimile-transmitted is recorded. The electronic data is data produced by a word-processor or data received by a facsimile machine. Hereinafter, the original document or the electronic data, which is to be subjected to image processing, is referred to as a document.

Moreover, the image data shall contain electronic data, which is acquired by reading an original document, and the above-mentioned electronic data. Accordingly, acquiring the image data means reading an original document and receiving the electronic data through a facsimile machine or a network.

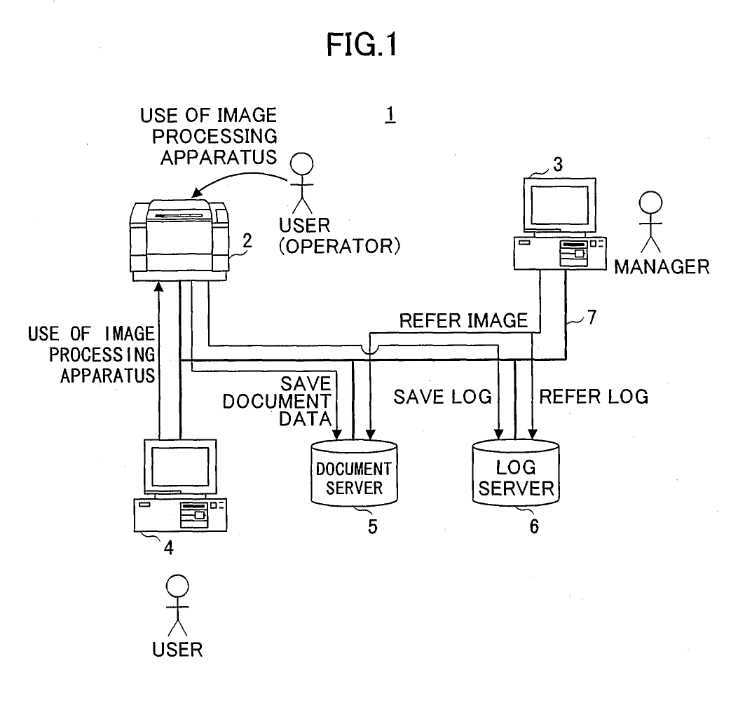

FIG. 1 is an illustration showing a structure of an image processing system 1 according to the present embodiment. The image processing system 1 shown in FIG. 1 comprises an image processing apparatus 2, a management PC 3, a client PC 4, a document server 5, a log server 6 and a network 7 connecting those components.

The image processing apparatus 2 has at least one of image processing functions of a printer, a scanner, a facsimile machine and a copy machine. The image processing apparatus 2 acquires image data from an original document and records the acquired image data. The management PC 3 functions as a display means for displaying the image data, contents of document data mentioned later and contents of log. The client PC 4 sends a request of printing to the image processing apparatus 2 so as to print, for example, the electronic data saved in the client PC 4.

The document server 5 functions as a document data storing part, and stores the document data containing the image data. The log server 6 functions as a log storing part, and stores the log information. The network 7 is, for example, a local area network (LAN). It should be noted that if the image processing apparatus 2 has a facsimile function, a telephone line is connected to the image processing apparatus 2. In such a case, the image processing apparatus 2 receives electronic data from a terminal not shown in the figure. In the description below, it is assumed that such a terminal is contained in the client PC 4.

The above-mentioned image processing system 1 can be constituted as a single image processing apparatus. In recent years, many multi-function peripheral machines, which are one of image processing apparatuses, are provided with a touch display panel as an operation panel and a hard disk drive. Such a multi-function peripheral machine is capable of displaying information by the operation panel instead of the management PC 3. Additionally, the hard disk drive can store the document data and the log instead of the document server 5 and the log server 6. Besides, there are many combinations such as combination of the document server 5 and the log server 6 as a single server.

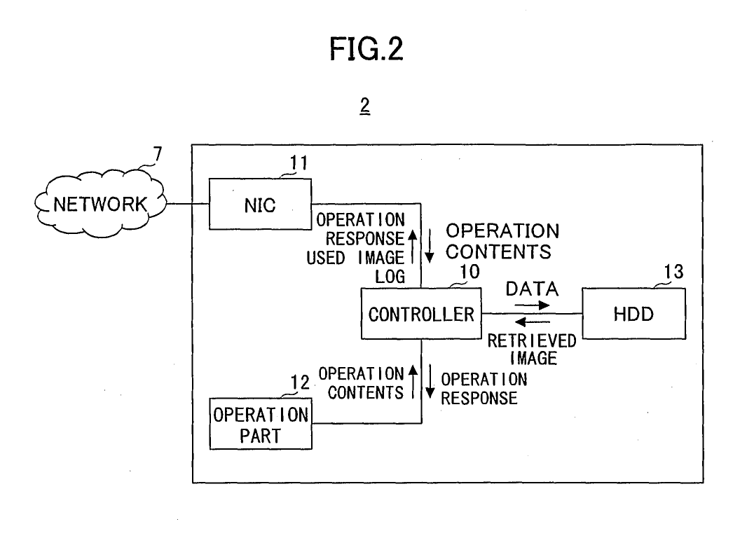

A description will now be given, with reference to FIG. 2, of a structure of the image processing apparatus 2. The image processing apparatus 2 includes a controller 10, a network interface controller (NIC) 11, a hard disk drive (HDD) 13 and an operation part 12. The HDD 13 is provided if necessary, and is not always needed in the present embodiment if the image processing apparatus 2 is provided with a memory having a sufficient capacity.

The controller 10 has a CPU, a RAM, a ROM, etc so as to control the image processing apparatus 2 according to software. The NIC 11 is an interface card for the network 7, and is used for receiving electronic data from the client PC 4 and controlling exchange of data with the document server 5 and the log server 6. The operation part 12 is an operation panel which displays information to a user and can be operated by the user. The HDD 13 is a hard disk drive unit used for temporarily storing data. The HDD 13 may be used for storing the above-mentioned document data and log information.

For example, when an operation of the image processing apparatus is sent through the NIC 11 from the network 7, the contents of the operation is sent to the controller 10. The controller 10 performs image creation or image processing based on the contents of the operation by using the image processing functions such as a printer, a scanner, a facsimile machine and a copy machine. Additionally, the controller 10 stores image data or other sets of data in the HDD 13, and retrieves the image data or other sets of data from the HDD 13 and processes the data. Then, the controller 10 sends to the network 7 through the NIC 11 an operation response with respect to the operation contents, the image data requested, the log information, etc. The operation contents may be input to the controller 10 through the operation part 12. In such a case, the controller returns an operation response with respect to the operation contents to the operation part 12, and the operation part 12 displays information based on the operation response.

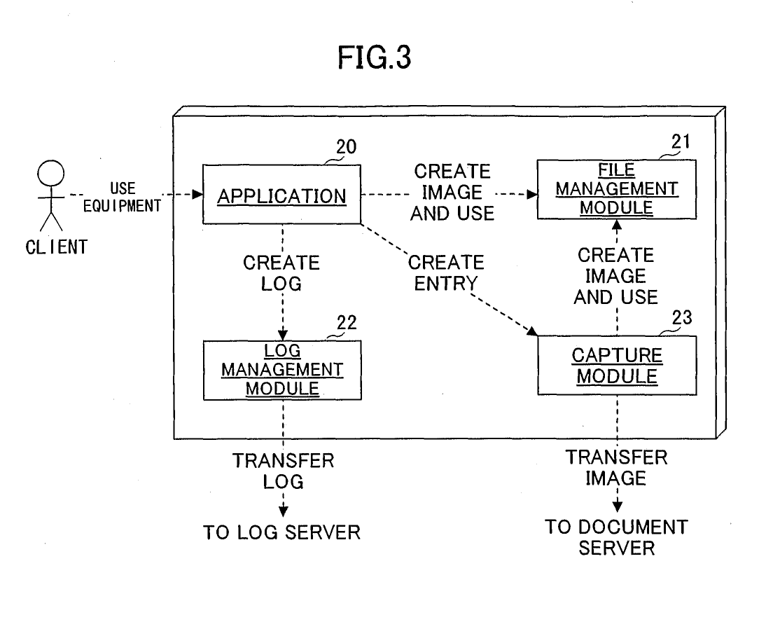

A description will now be given, with reference to FIG. 3, of a software structure of the image processing apparatus 2. FIG. 3 shows an application 20, a file management module 21, a log management module 22 and a capture module 23.

The application 20 is an application of one of a copy, a facsimile, a scanner and a printer, and serves as a log creating part. The log management module 22 is a module serving as a log saving part, and records log information created by the application 20 by transferring the log information to the log server 6. As mentioned later, the log management module 22 can transfer the log information after converting the log information, which is described by program codes, into XML.

The file management module 21 converts image data and creates document data containing the image data. It should be noted that the conversion of image data means a format conversion of the acquired image data when formats of image data are different from each other, for example, in cases of copy and facsimile transmission.

The capture module 23 serves as a document data storing part. The capture module 23 sends a request to the file management module 21 to change the acquired image data to the document data, and creates the document data by adding bibliography information to the image data and transfers the thus-created document data to the document server 5. As mentioned later, the capture module 23 is capable of creating the bibliography information by describing in XML.

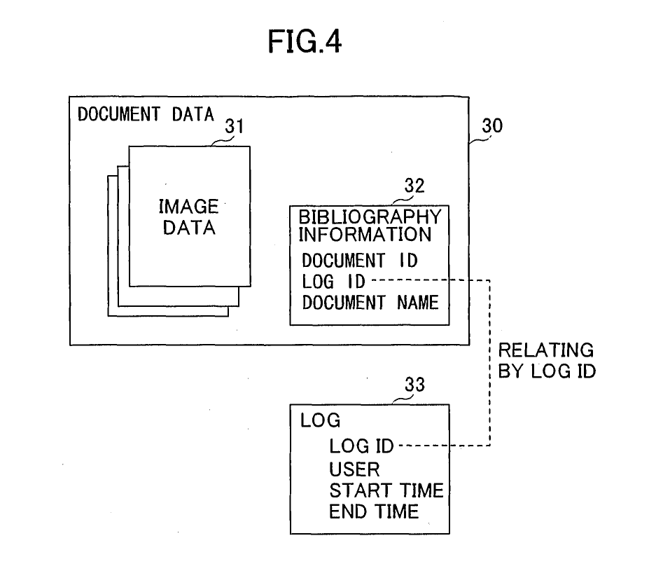

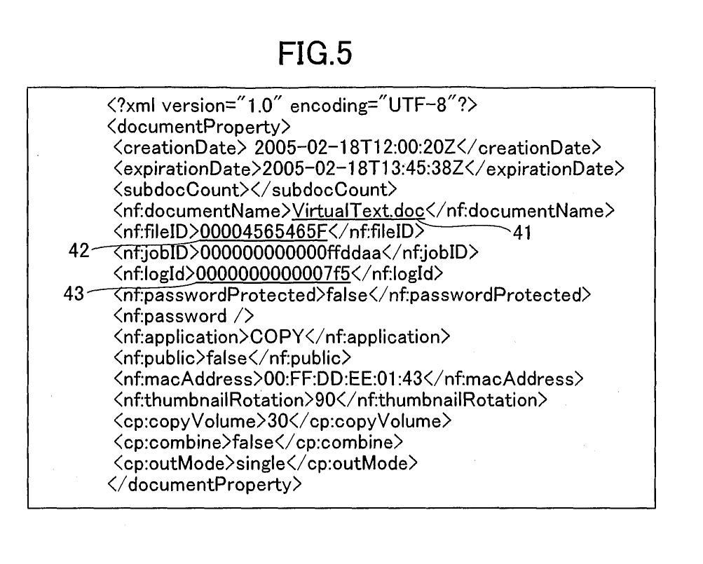

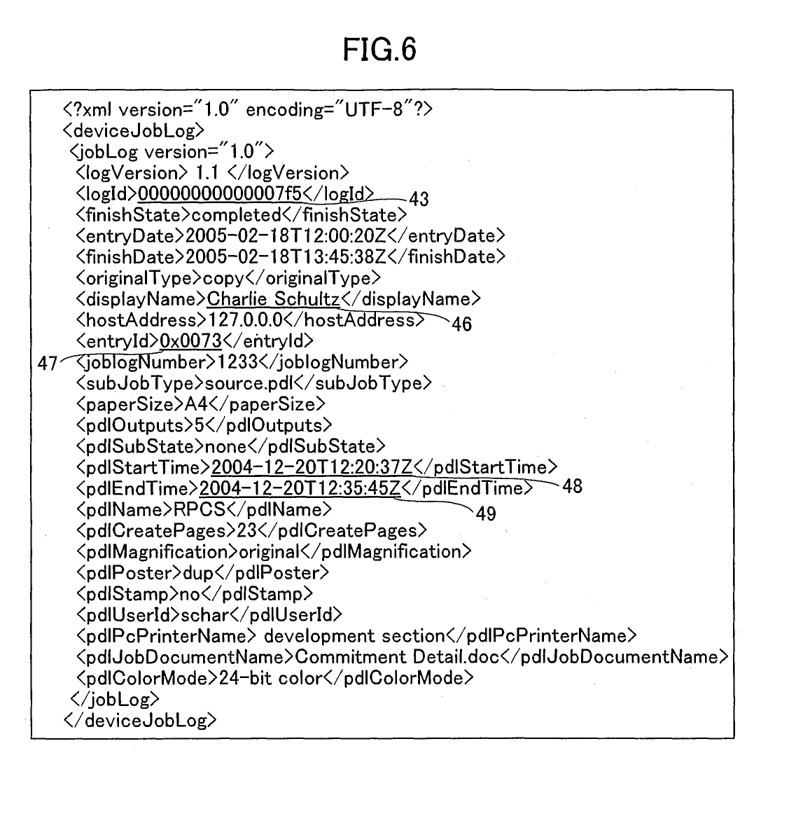

A description will be given, with respect to FIG. 4, of an outline of the document data and the log information (hereinafter, simply referred to as log). The detail of the document data and the log information will be described with reference to FIGS. 5 and 6. FIG. 4 shows document data 30 and log 33. The document data 30 contains image data 31 and bibliography information 32. The image data 31 has been explained before. There are plural sets of image data 31 in FIG. 40. For example, each set of image data corresponds to image data of each page of a document.

The bibliography information 32 contains a document ID, a log ID and a document name. The document ID is identification information (ID) for identifying the document data. The log ID is identification information (ID) for identifying the log. The document name is a name of the document data.

A description will now be given of the log 33. The log 33 contains information regarding the log ID, a user, a start time and an end time. The log ID has been explained before. Each of the document data 30 and the log 33 contains the log ID for identifying the log. Thereby, the document data 30 and the log 33 are related to each other. The user is a person designating the processing, and the user can be identified by the user information contained in the log 33. The start time is a time at which the processing was started, and the end time is a time at which the processing was ended. In the present embodiment, the log 33 is described in XML.

A description will now be given, with reference to FIG. 5, of details of the bibliography information 32. In the present embodiment, the bibliography information 32 and the log ID explained below are described in XML. However, it is not limited 25- to the description in XML, and mere a text or a binary may be used.

The bibliography information shown in FIG. 5 is described in XML, and contains character strings 41, 42 and 43. The character string 41 “VirtualText.doc” is a document name. The document name is indicated by a tag <nf:documentName>. The character string 42 “00004565465F” is a document ID. The document ID is indicted by a tag <nf:fileID>. The log ID is indicated by a tag <nf:logId>. In addition, the bibliography information contains a tag <nf:application>, which indicates what image processing was performed.

A description will now be given, with reference to FIG. 6, of details of the log. The log information shown in FIG. 6 is described in XML, and contains character strings 43, 46, 47, 48 and 49. The character string 43 is the log ID which is also present in the bibliography information. The character string 46 “Charlie Schultz” is an account of a user who designates the processing. The user's account is indicated by a tag <displayName>. Moreover, the character string 47 “0×0073” is an ID for identifying a userand indicated by a tag <entryId>. The character string 48 “2004-12-20T12:20:37 Z” is a start time, which is indicated by a tag <pdlStartTime>. The character string 49 “2004-12-20T12:35:45 Z” is an end time, which is indicated by a tag <pdlEndTime>.

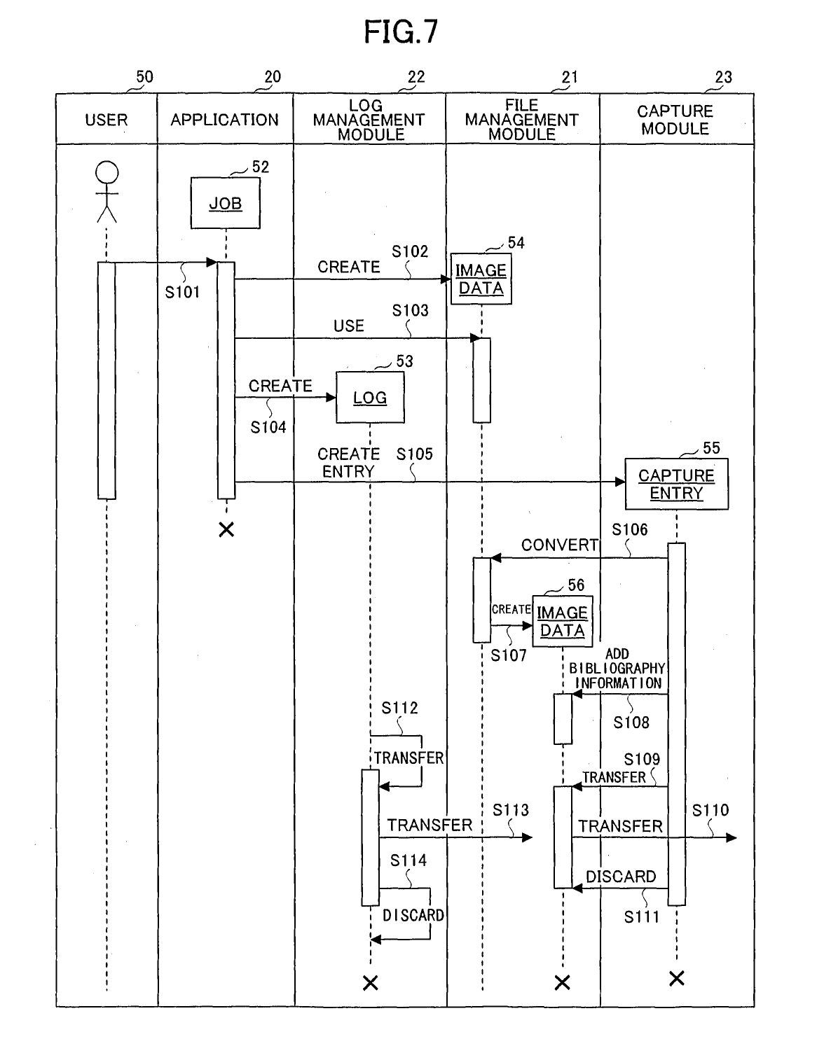

A description will now be given, with reference to FIG. 7, of a process for relating the log and the document data to each other. FIG. 7 is a sequence chart of a process performed by the application 20, the log management module 22, the file management module 21 and the capture module 23.

In step S11, a job 52 is generated by a user pressing, for example, a copy button, and an original document is scanned. The job 52 is generated in response to a copy and a facsimile. In step S102, the job 52 causes the file management module 52 to generate image data 54. The image data 54 is generated according to a copy format if it is a copy image. In step S103, the job 52 performs a copy by using the generated image data 54.

Next, the job 52 requests the log management module 22 to generate log. Then, a log 53, which is a process of generating the log, is activated. The log 53 performs a process of transferring the log from parameters regarding the log received from the job 52 (step S112). The log 53 records the log by transferring the log in step S113, and, thereafter, discards the log in step S114.

On the other hand, the job 53 requests, in step S105, generation of the document data to the capture module 23. Thus, a capture entry 55, which is a process of generating the document data, is activated. The capture entry 55 converts the image data 54 used for the aforementioned copy into image data to be saved. According to the conversion, new image data 56 is generated in step S107.

The capture entry 55 adds, in step S108, the bibliography information to the image data 56. Then, the capture entry 55 records the document data by transferring the document data containing the image data 56 in steps S109 and S110, and thereafter, discards the document data in step S111.

In the above-mentioned process, the log ID is notified by the job 52 in steps S104 and S105. The log ID is the same one, and the generated log and the document data have the same ID. Thereby, the log and the image data contained in the document data are related to each other.

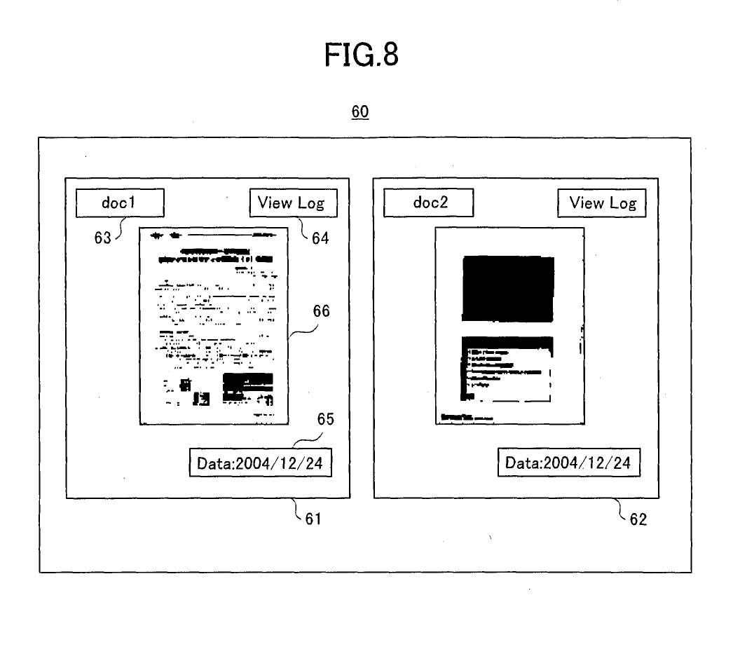

A description will now be given, with reference to FIG. 8, of display of the image data. FIG. 8 is an illustration showing a screen displaying the log and the image data. Log information display parts 61 and 62 are displayed on the screen 60. Each of the log information display parts 61 and 62 is for displaying image data and log of the image data. A description will be given below of the log information display part using the log information display part 61.

Displayed on the log information display part 61 are a document name 63, a log review button 64, a date 65, and image data 66. The document name 63 is a document name of the document data containing the image data. The log review button 64 is a button for reviewing the details of the log. The date 65 indicates the date when the log was taken.

It should be noted that although two sets of log information are displayed on the screen 60, the number of sets of log information is not limited to two and one or more than 2 sets of log information may be displayed.

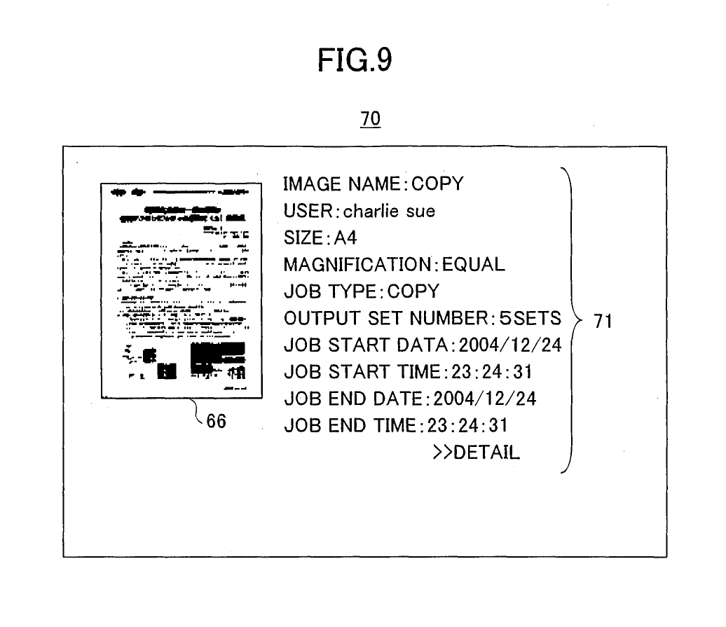

When the log review button 64 is pressed on the screen 60, a detail screen 70 shown in FIG. 9 is displayed. Image data 66 and detailed log information 71 are displayed on the detail screen 70. Displayed in the detailed information 71 are a picture name, a user, a size, a magnification, a job type, an output number of copies, a job start day, a job start time, a job end day, and job end time. Additionally, further detail can be displayed by clicking “>>detail”.

As mentioned above, the contents of the document data other than the image data thereof and the contents of the log are displayed on the display screen together with the image data. Thereby, it is possible to identify not only the processed date and time, the user and the document name but also the processed image data.

In the above-mentioned embodiment, the bibliography information 32 contained in the document data saved in the document server 5 and the log 33 saved in the log server 6 are described in XML. Although those sets of data may be described in other description formats, the following effects can be obtained by using XML.

When describing each item of the log information by XML, each item is sandwiched between a pair of identifiers referred to as tags as shown in FIG. 5 and FIG. 6. For example, in the bibliography information described in XML shown in FIG. 5, the item indicating a document name is “VirtualText.doc” sandwiched between the tags <nf.documentName> and </nf.documentName>. In XML, the tags can be deleted or added freely. That is, by describing by the MXL, a number of items to be managed in the log information can be decreased or increased without changing programs.

In the present embodiment, even if, for example, a version of the log management function is upgraded, an old version apparatus and a new version apparatus can be mixed in the same system and log management can be carried out simultaneously.

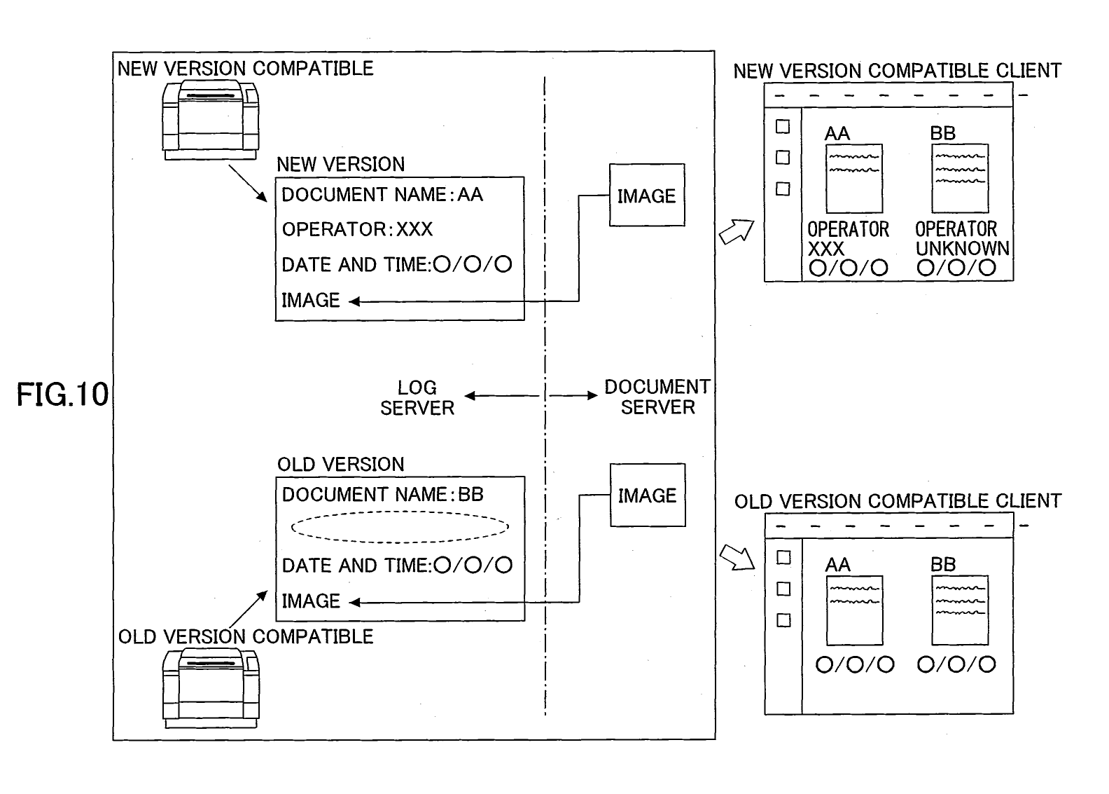

For example, it is assumed that there is a case where an image processing apparatus corresponding to a log management function of a new version and an image processing apparatus corresponding to a log management function of an old version are provided in one system. Here, as shown in FIG. 10, it is assumed that “operator” is not included in the log management items of the old version and “operator” is provided as one of the log management items of the new version. In this case, the item of “operator” exists in the log of a document AA, which has been processed by the new version image processing apparatus, but the item of “operator” exists in the log of a document BB, which has been processed by the old version image processing apparatus.

In above-mentioned circumstances, when extracting and viewing the log by a client PC having the new version log management function in the system, an operator “XXX” is displayed in the log of the document AA, and no operator is displayed in the log of the document BB and “unknown” is displayed instead. On the other hand, when extracting and viewing the log by a client PC having the old version log management function in the system, the item of operator itself is not displayed in the log of the document AA and the item of operator is not displayed in the log of the document BB as well.

Thus, even if a management item in the log information is changed, the client PC of the old version can manage the document, with the old version, which has been processed by the image processing apparatus dealing with the new version, and the client PC of the new version can manage the document, with the new version, which has been processed by the image processing apparatus dealing with the old version.

Additionally, the log information saved in the log server 6 can be compressed by deleting items so that items common to the new version and the old version remain in the log information. Or, the log information can be compressed by thinning items in the detail of the log. Thereby, a size of the log saved in the log server 6 can be reduced, which enables reduction in the capacity of the log server 6 or saving a larger amount of log in the log server.

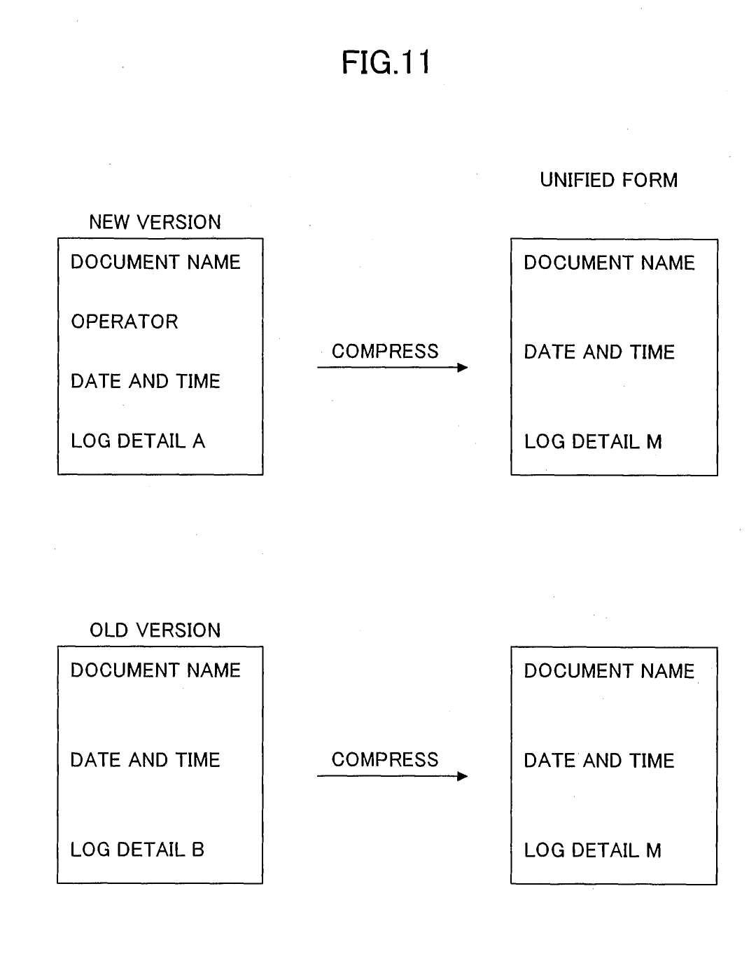

FIG. 11 is an illustration showing an example of compression of a log saved in the log server. The log information according to the new version contains a document name, an operator, data and time, and a log detail A, and the log information according to the old version contains a document name, date and time and a log detail B. Thus, some items are deleted from each of the log information according to the new version and the log information according to the old version so as to unify the items in the log so that the logs of the new version and the old version having the same items are created and saved in the log server 6. In FIG. 11, the unified log contains the document name, the date and time, and a log detail M. That is, the item of operator, which exists only in the new version, is deleted so that each of the log details A and B is changed into the log detail M having items common to the new and old versions.

As mentioned above, by compressing the log saved in the log server 6, a larger amount of logs can be saved in the log server 6, or the capacity of the log server 6 can be reduced. On the other hand, if possible, it is necessary to reduce the amount of document data saved in the document server 5.

Here, when transmitting the same image to a plurality of remote parties like broadcasting communications, a plurality of sets of document data 30 are created according to the plurality of remote parties, and saved or stored in the document server 5. Each of the sets of document data 30 contains the same image data 31. Thus, like a case of broadcasting communication, a parent log 33A is provided as a job of the broadcasting communication, and a child log 33B, which is related to the parent log 33A, is provided to each of the remote parties. Then, the document data saved in the document server 5 is limited to document data containing a log ID as bibliography information of the parent log 33A. The parent log 33A the child logs 33A related to the parent log 33A are saved or stored in the log server 6. That is, by incorporating the ID of the parent log 33A in each of the child logs 33B, the parent log 33A and each of the child logs 33B are related to each other. Thereby, there is no need to save or store in the document server 5 a plurality of sets of document data containing the same image data and bibliography information of which only a part is different. Thus, an amount of document data saved or stored in the document server 5 can be reduced.

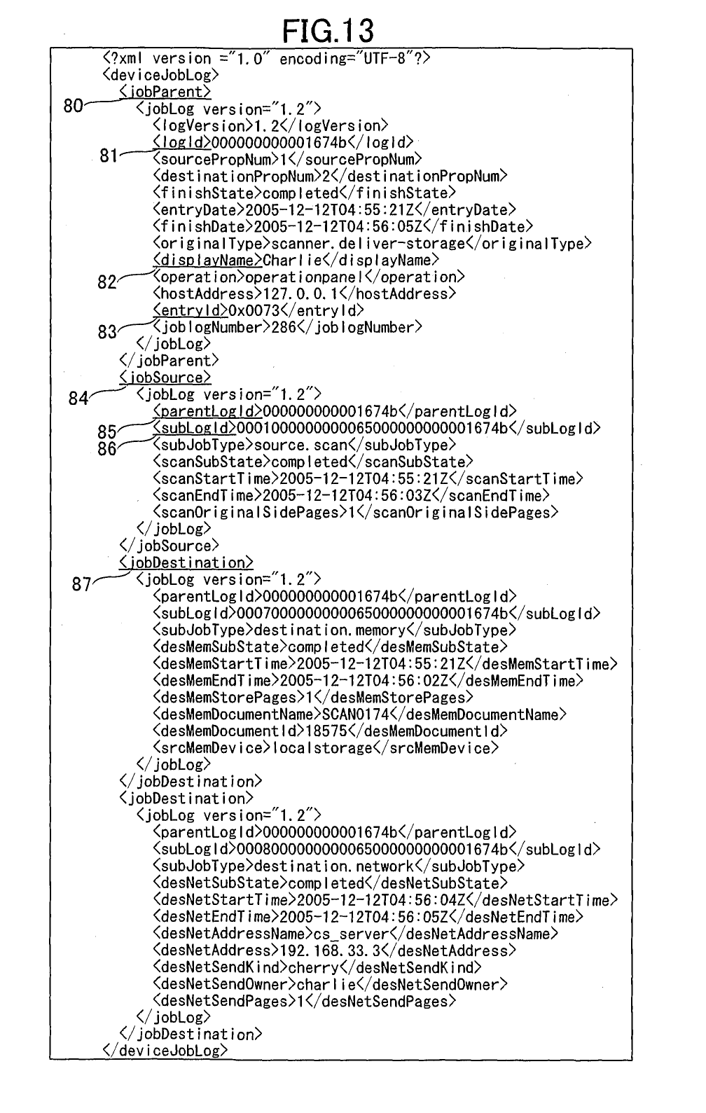

FIG. 13 is an illustration showing details of a log of a job having a parent-child relationship. In FIG. 13, <jobParent> indicated by the reference sing 80 is a tag representing a parent job. <logId/> indicated by a reference sign 81 is a tag representing a log ID. <displayName> indicated by a reference sign 82 is a tag representing a display name. <entryId> indicated by a reference sign 83 is a tag representing an ID of an operator. <jobSource> indicated by a reference sign 84 is a tag representing a jog of image creation among child jobs. <parentLogLogId> indicated by a reference sign 85 is a tag representing a log ID of the parent job. <subLogId> indicated by a reference sign 86 is a tag representing an ID of the child job. <jobDestination> indicated by a reference sign 87 is a tag representing a job using an image among the child jobs.

Since document data contains image data, the size of the document data is large and a very large capacity is required to the document server 5. The present invention aims to provide an effect of preventing an illegal action by providing a function to specify a person who conducted an illegal use of image data or illegal action with respect to image data. In order to prevent an illegal action, there is a sufficient effect of prevention if all jobs are not recorded and logs are recorded on jobs extracted by sampling. For example, persons other than the managers of the system are not notified of the fact that the logging is taken by sampling. Or, even if each person knows the fact of sampling, a person intending to conduct an illegal action may think that the action may be sampled and scruple conducting the illegal action.

As mentioned above, by saving the image data and the log information only with respect to the sampled jobs, an amount of data stored in the document server 5 and the log server 6 can be reduced very much.

It should be noted that if taking logs by sampling jobs and taking logs of all jobs are switchable therebetween, or if a probability (frequency) of sampling is changeable, an illegal action can be prevented effectively while reducing an amount of, data stored in the document server 5 and the log server 6. For example, frequency of sampling may be raised at a time period or at a place where an illegal action tends to be conducted.

The present invention is not limited to the specifically disclosed embodiments, and variations and modifications may be made without departing from the scope of the present invention.

The present application is based on Japanese priority applications No. 2005-240303 filed Aug. 22, 2005 and No. 2006-195981 filed Jul. 18, 2006, the entire contents of which are hereby incorporated herein by reference.

1. An image processing system for processing image data, comprising:
a log creating part that acquires log information regarding processing of the image data;
a log saving part that saves the log information;
a document data saving part that saves as document data the image data and a log ID for identifying the log information, the image data and the log ID being related to each other; and
a display part that displays said image data and said log information corresponding to said image data, wherein
said log saving part saves, when increasing or decreasing a number of items of the log information to be saved, the log information of items that have been increased or decreased without changing the items of the log information that have been saved; and
said display part displays specific items of the log information irrespective of the items which the log information corresponding to the image data saves.

2. The image processing system as claimed in claim 1, wherein said document data further includes at least one of a document ID for identifying said document data and a document name which is a name of said document data.

3. The image processing system as claimed in claim 1, wherein said log information includes at least one of a user who designated said processing, a time at which said processing was started, and a time at which said processing was ended.

4. The image processing system as claimed in claim 1, further comprising a document data storing part in which said document data is stored and a log storing part in which said log information is stored.

5. (canceled)

6. The image processing system as claimed in claim 1, wherein said log saving part and said document saving part describe said log information and said log ID in XML and save said log information and said log ID.

7. (canceled)

8. (canceled)

9. The image processing system as claimed in claim 1, wherein when there are a plurality of jobs with respect to the same image data, the document data having one log ID is stored in a document data storing part, and the log information containing the one log ID is set as a parent log and log information corresponding to each of the plurality of jobs is set as a child log so as to store the parent log and the child log in a log storing part.

10. The image processing system as claimed in claim 1, wherein said log saving part and said document data saving part save said log information and said log ID with respect to a job extracted by sampling.

11. The image processing system as claimed in claim 10, wherein a frequency of said sampling is changeable.

12. An image processing method for processing image data, comprising:
acquiring log information regarding processing of the image data; and
saving the log information and also saving as document data the image data and a log ID for identifying the log information.

13. The image processing method as claimed in claim 12, wherein at least one of a document ID for identifying said document data and a document name which is a name of said document data is included further in said document data.

14. The image processing method as claimed in claim 12, wherein at least one of a user who designated said processing, a time at which said processing was started, and a time at which said processing was ended is included in said log information.

15. The image processing method as claimed in claim 12, further comprising describing said log information and said log ID in XML when saving said log information and said log information.

16. The image processing method as claimed in claim 15, wherein at least one of items of said log information is deleted when displaying said log information.

17. The image processing method as claimed in claim 12, wherein at least one of items of said log information is deleted when saving said log information.

18. The image processing method as claimed in claim 12, wherein said log information and said log ID are saved with respect to a job extracted by sampling.

19. A computer executable image processing program causing a computer to perform an image processing method for processing image data, comprising:
acquiring log information regarding processing of the image data; and
saving the log information and also saving as document data the image data and a log ID for identifying the log information.

20. An image forming apparatus for processing an image using image data, comprising:
a log creating part that acquires log information regarding processing of the image data;
a log saving part that saves the log information;
a document data saving part that saves as document data the image data and a log ID for identifying the log information, the image data and the log ID being related to each other; and
a display part that displays said image data and said log information corresponding to said image data, wherein
said log saving part saves, when increasing or decreasing a number of items of the log information to be saved, the log information of items that have been increased or decreased without changing the items of the log information that have been saved; and
said display part displays specific items of the log information irrespective of the items which the log information corresponding to the image data saves.
